(19) United States
(12) Patent Application Publication
(10) Pub. No.: US 2025/0218687 A1
(43) Pub. Date: Jul. 3, 2025

(54) MULTILAYER ELECTRONIC COMPONENT

(71) Applicant: SAMSUNG ELECTRO-MECHANICS CO., LTD., Suwon-si (KR)

(72) Inventors: Seung Yeon LEE, Suwon-si (KR); Young Don CHOI, Suwon-si (KR); Gyeong Ju SONG, Suwon-si (KR); Sang Eon PARK, Suwon-si (KR); Hyun Min LIM, Suwon-si (KR); Sung Hyung KANG, Suwon-si (KR); Sung Soon CHAE, Suwon-si (KR)

(73) Assignee: SAMSUNG ELECTRO-MECHANICS CO., LTD., Suwon-si (KR)

(21) Appl. No.: 18/971,304

(22) Filed: Dec. 6, 2024

(30) Foreign Application Priority Data
Dec. 29, 2023 (KR) 10-2023-0197242

(51) Int. Cl. H01G 4/30; H01G 2/06; H01G 4/008; H01G 4/012; H01G 4/12; H01G 4/224

(52) U.S. Cl. CPC H01G 4/30; H01G 2/065; H01G 4/008; H01G 4/012; H01G 4/12; H01G 4/224

(57) ABSTRACT

A multilayer electronic component includes a body including a capacitance formation portion including a dielectric layer and first and second internal electrodes disposed alternately in a first direction with the dielectric layer interposed therebetween, and cover portions disposed in an upper portion and a lower portion of the capacitance formation portion in the first direction; and external electrodes disposed on the body, wherein the capacitance formation portion includes outer regions adjacent to the cover portion and a central region other than the outer region, and wherein an average thickness of the first internal electrode included in the outer region is greater than an average thickness of the first internal electrode included in the central region, and an average thickness of the second internal electrode included in the outer region is greater than an average thickness of the second internal electrode included in the central region.

### CROSS-REFERENCE TO RELATED APPLICATION(S)

The application claims the benefit of priority to Korean Patent Application No. 10-2023-0197242 filed on Dec. 29, 2023 in the Korean Intellectual Property Office, the disclosure of which is incorporated herein by reference in its entirety.

### TECHNICAL FIELD

The present disclosure relates to a multilayer electronic component.

### BACKGROUND

A multilayer ceramic component (MLCC), a multilayer electronic component, may be a chip condenser mounted on the printed circuit boards of various electronic products including image display devices such as a liquid crystal display (LCD) and a plasma display panel (PDP), a computer, a smartphone, a mobile phone, or the like, and charging or discharging electricity therein or therefrom.

Such a multilayer ceramic capacitor may be used as a component of various electronic devices, since a multilayer ceramic capacitor may have a small size and high capacitance and may be easily mounted. Recently, as electronic devices such as computers and mobile devices have been designed to have a reduced size and a high performance, a multilayer ceramic capacitor has also been designed to have a reduced size and a high capacitance, and according to this trend, the importance of ensuring high reliability of a multilayer ceramic capacitors has increased. Also, high reliability and high strength properties may be necessary to be used in automotive electronic components.

Generally, as for a multilayer ceramic capacitor, a ceramic green sheet having an internal electrode pattern printed thereon may be laminated and pressed, and may be sintered to form a body. During a pressing process, deformation stress may increase in internal electrodes disposed in an outermost region in a lamination direction, such that internal electrodes disposed in the outermost region in a lamination direction may have deteriorated connectivity between internal electrodes or a reduced thickness, and accordingly, connectivity between the internal electrode and the external electrode may be deteriorated or warpage strength properties may be deteriorated.

### SUMMARY

An embodiment of the present disclosure is to provide a multilayer electronic component having improved reliability.

An embodiment of the present disclosure is to provide a multilayer electronic component in which connectivity between internal electrodes and external electrodes may be excellent.

An embodiment of the present disclosure is to provide a multilayer electronic component having improved capacitance.

According to an embodiment of the present disclosure, a multilayer electronic component includes a body including a capacitance formation portion including a dielectric layer and first and second internal electrodes disposed alternately in a first direction with the dielectric layer interposed therebetween, and cover portions disposed in an upper portion and a lower portion of the capacitance formation portion in the first direction; and external electrodes disposed on the body, wherein the capacitance formation portion includes outer regions adjacent to the cover portion and a central region other than the outer region, and wherein an average thickness of the first internal electrode included in the outer region is greater than an average thickness of the first internal electrode included in the central region, and an average thickness of the second internal electrode included in the outer region is greater than an average thickness of the second internal electrode included in the central region.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a perspective diagram illustrating a multilayer electronic component according to an embodiment of the present disclosure;

FIG. 2 is a cross-sectional diagram taken along line I-I′ in FIG. 1;

FIG. 3 is a cross-sectional diagram taken along line II-II′ in FIG. 1;

FIG. 4 is an exploded diagram illustrating a body according to an embodiment of the present disclosure;

FIG. 5 is a diagram illustrating thickness of an outer region and a central region, corresponding to FIG. 3.

### DETAILED DESCRIPTION

Hereinafter, embodiments of the present disclosure will be described as below with reference to the accompanying drawings.

These embodiments are described in sufficient detail to enable those skilled in the art to practice the invention. It is to be understood that the various embodiments of the invention, although different, are not necessarily mutually exclusive. For example, structures, shapes, and sizes described as examples in embodiments in the present disclosure may be implemented in another embodiment without departing from the spirit and scope of the present disclosure. Further, modifications of positions or arrangements of elements in embodiments may be made without departing from the spirit and scope of the present disclosure. The following detailed description is, accordingly, not to be taken in a limiting sense, and the scope of the present invention are defined only by appended claims, appropriately interpreted, along with the full range of equivalents to which the claims are entitled.

In the drawings, same elements will be indicated by same reference numerals. Also, redundant descriptions and detailed descriptions of known functions and elements which may unnecessarily make the gist of the present disclosure obscure will be omitted. In the accompanying drawings, some elements may be exaggerated, omitted or briefly illustrated, and the sizes of the elements do not necessarily reflect the actual sizes of these elements. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

In the drawings, the first direction may be defined as a thickness (T) direction, the second direction may be defined as a length (L) direction, and the third direction may be defined as a width (W) direction.

### Multilayer Electronic Component

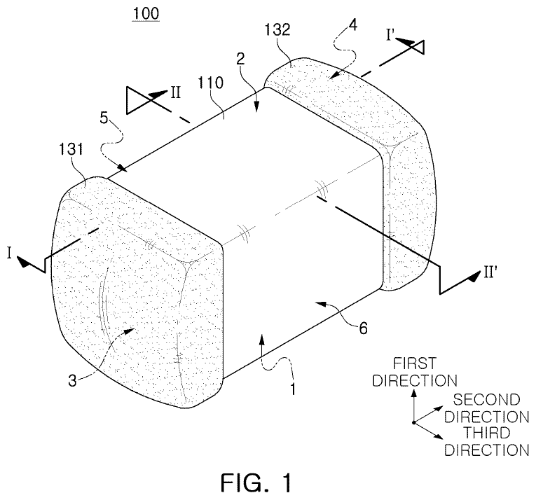

FIG. 1 is a perspective diagram illustrating a multilayer electronic component according to an embodiment.

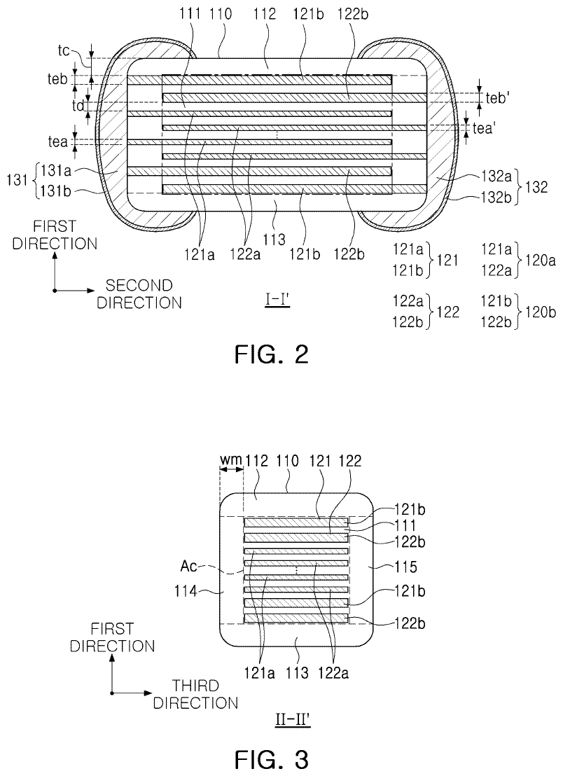

FIG. 2 is a cross-sectional diagram taken along line I-I′ in FIG. 1.

FIG. 3 is a cross-sectional diagram taken along line II-II′ in FIG. 1.

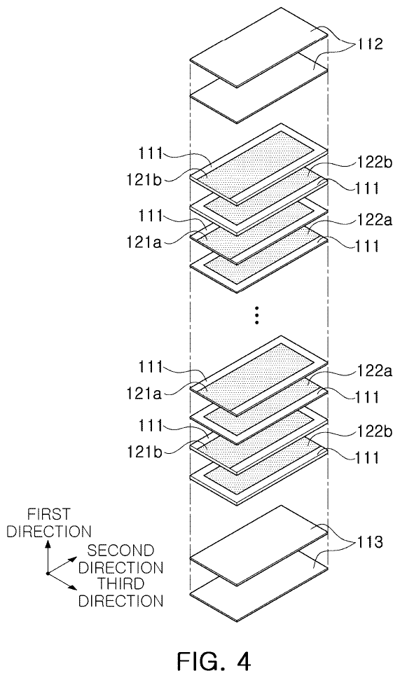

FIG. 4 is an exploded diagram illustrating a body according to an embodiment.

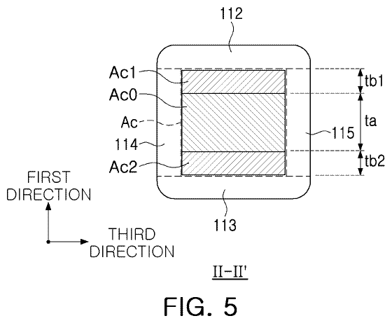

FIG. 5 is a diagram illustrating thickness of an outer region and a central region, corresponding to FIG. 3.

Hereinafter, a multilayer electronic component 100 according to an embodiment will be described in greater detail with reference to FIGS. 1 to 5. A multilayer ceramic capacitor will be described as an example of a multilayer electronic component (hereinafter, MLCC), but an embodiment thereof is not limited thereto, and the multilayer ceramic capacitor may be applied to various multilayer electronic components, such as an inductor, a piezoelectric element, a varistor, or a thermistor.

The multilayer electronic component 100 may include a body including a capacitance formation portion Ac including a dielectric layer 111 and first and second internal electrodes 121 and 122 disposed alternately in a first direction with the dielectric layer interposed therebetween, and cover portions 112 and 113 disposed in upper and lower portions of the capacitance formation portion in the first direction; and external electrodes 131 and 132 disposed on the body, wherein the capacitance formation portion includes outer regions Ac1 and Ac2 adjacent to the cover portion and a central region Ac0 other than the outer region, and wherein an average thickness teb of the first internal electrode included in the outer region is greater than an average thickness tea of the first internal electrode included in the central region, and an average thickness teb′ of the second internal electrode included in the outer region is greater than an average thickness tea′ of the second internal electrode included in the central region.

A multilayer ceramic capacitor may generally be formed by laminating and pressing a ceramic green sheet having an internal electrode pattern printed thereon, and then sintering to form a body. During the pressing process, the deformation stress increases in the internal electrodes disposed in the outermost region in a lamination direction, so that the internal electrode connectivity of the internal electrodes disposed in the outermost region in a lamination direction may be deteriorated or the thickness may be reduced, thereby deteriorating the connectivity between the internal electrode and the external electrode.

According to an embodiment, by increasing a thickness of the internal electrode adjacent to the cover portion, connectivity between internal electrodes disposed in the outermost region may be prevented from being deteriorated or the thickness thereof may be prevented from being reduced, thereby improving connectivity between the internal electrode and the external electrode and warpage strength properties.

Hereinafter, each component included in the multilayer electronic component 100 according to an embodiment will be described.

In the body 110, the dielectric layers 111 and the internal electrodes 121 and 122 may be alternately laminated.

The shape of the body 110 may not be limited to any particular shape, but as illustrated, the body 110 may have a hexahedral shape or a shape similar to a hexahedral shape. Due to reduction of ceramic powder included in the body 110 during a firing process or polishing of corners, the body 110 may not have an exactly hexahedral shape formed by linear lines but may have a substantially hexahedral shape.

The body 110 may have the first and second surfaces 1 and 2 opposing each other in the first direction, the third and fourth surfaces 3 and 4 connected to the first and second surfaces 1 and 2 and opposing in the second direction, and the fifth and sixth surfaces 5 and 6 connected to the first and second surfaces 1 and 2 and the third and fourth surfaces 3 and 4 and opposing each other in the third direction.

Since the margin region in which the internal electrodes 121 and 122 are not disposed overlaps the dielectric layer 111, a step difference may be formed due to the thickness of the internal electrodes 121 and 122, and a corner connecting the first surface to the third to fifth surfaces and/or a corner connecting the second surface to the third to fifth surfaces may have a reduced shape toward the center in first direction of the body 110 when viewed from the first surface or the second surface. Alternatively, due to shrinkage behavior during the sintering process of the body, a corner connecting the first surface 1 to the third to sixth surfaces 3, 4, 5, and 6 and/or a corner connecting the second surface 2 to the third to sixth surfaces 3, 4, 5, and 6 may have a reduced shape toward the center in the first direction of the body 110 when viewed from the first surface or the second surface. Alternatively, to prevent chipping defects, the corners connecting the surfaces of the body 110 may be rounded by performing a specific process to round the corners, such that each of the corners connecting the first surface to the third to sixth surfaces and/or the corners connecting the second surface to the third to sixth surfaces may have a rounded shape.

To suppress the step difference formed by the internal electrodes 121 and 122, when the internal electrodes are cut out to be exposed to the fifth and sixth surfaces 5 and 6 of the body after lamination, a dielectric layer or two or more dielectric layers are laminated in the third direction (width direction) on both side surfaces of the capacitance formation portion Ac to form the margin portions 114 and 115, the portion connecting the first surface to the fifth and sixth surfaces and the portion connecting the second surface to the fifth and sixth surfaces may not have a reduced shape.

The plurality of dielectric layers 111 forming the body 110 may be in a fired state, and boundaries between adjacent dielectric layers 111 may be integrated with each other such that boundaries therebetween may not be distinguishable without using a scanning electron microscope (SEM). It may not be necessary to specifically limit the number of laminates of the dielectric layer, and the number of laminates may be determined by considering the size of the multilayer electronic component. For example, the body may be formed by laminating 400 or more layers of the dielectric layer.

The dielectric layer 111 may be formed by preparing a ceramic slurry including ceramic powder, an organic solvent, an additive, and a binder, preparing a ceramic green sheet by coating the slurry on a carrier film drying the slurry, and firing the ceramic green sheet. The ceramic powder is not limited to any particular example as long as sufficient electrostatic capacitance may be obtained. For example, powder based on barium titanate (BaTiO₃) and paraelectric powders based on CaZrO₃ may be used as ceramic powder. The ceramic powder may be one or more of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1).

The average thickness td of the dielectric layer 111 may not be limited to any particular example, and may be, for example, 0.1 μm to 10 μm. Also, the average thickness td of the dielectric layer 111 may be arbitrarily set depending on the desired properties or purpose.

The average thickness td may indicate the sizes in the first direction of the dielectric layer 111 disposed between the internal electrodes 121 and 122. The average thickness td of the dielectric layer 111 may be measured by scanning the cross-sections of the body 110 in the first and second directions using a scanning electron microscope (SEM) at 10,000 magnification. More specifically, the average thickness of the dielectric layer 111 may be measured by measuring the thickness at multiple points of the dielectric layer 111, for example, 30 points at equal distances in the second direction. The 30 points at equal distance may be designated in the capacitance formation portion. Meanwhile, by measuring the average value on 10 dielectric layers 111, and the average thickness of the dielectric layer 111 may be further generalized.

In an embodiment, when the average thickness of the dielectric layer included in the central region Ac0 is defined as tda and the average thickness of the dielectric layer included in the outer regions Ac1 and Ac2 is defined as tdb, 0.9≤tdb/tda≤1.1 may be satisfied. That is, the average thickness td of the dielectric layer 111 may be substantially the same as the average thickness of the dielectric layer included in the central region Ac0 and the average thickness of the dielectric layer included in the outer regions Ac1 and Ac2, differently from the internal electrode.

The body 110 may include a capacitance formation portion Ac forming capacitance including the first internal electrode 121 and the second internal electrode 122 disposed in the body 110 and opposing each other with the dielectric layer 111 therebetween, and cover portions 112 and 113 formed in upper and lower portions of the capacitance formation portion Ac in the first direction.

Also, the capacitance formation portion Ac may contribute to forming the capacitance of the capacitor, and may be formed by repeatedly laminating the plurality of first and second internal electrodes 121 and 122 with the dielectric layer 111 interposed therebetween.

The cover portions 112 and 113 may include an upper cover portion 112 disposed on the capacitance formation portion Ac in the first direction and a lower cover portion 113 disposed in a lower portion of the capacitance formation portion Ac in the first direction.

The upper cover portion 112 and the lower cover portion 113 may be formed by laminating a single dielectric layer or two or more dielectric layers on the upper and lower surfaces of the capacitance formation portion Ac in the thickness direction, respectively, and may basically prevent damages to the internal electrode due to physical or chemical stress.

The upper cover portion 112 and the lower cover portion 113 may not include an internal electrode and may include the same material as a material of the dielectric layer 111. That is, the cover portions 112 and 113 may include the dielectric layer 111 and may not include the first and second internal electrodes 121 and 122. Also, the cover portions 112 and 113 may include the dielectric layer 111 and may not include a dummy electrode. That is, according to an embodiment, warpage strength may be improved by controlling the thickness of the internal electrode in different positions rather than improving warpage strength through the dummy electrode, thereby assuring higher capacitance than when the dummy electrode is disposed.

That is, the upper cover portion 112 and the lower cover portion 113 may include a ceramic material, and may include, for example, a barium titanate (BaTiO₃) ceramic material.

The thickness of the cover portions 112 and 113 may not be limited to any particular example. For example, the average thickness tc of the cover portions 112 and 113 may be 5-500 μm.

The average thickness tc of the cover portions 112 and 113 may indicate the size in the first direction, and may be an average value of the sizes in the first direction of the cover portions 112 and 113 measured at five points at an equal distance in an upper portion and a lower portion of the capacitance formation portion Ac.

Also, margin portions 114 and 115 may be disposed on side surfaces of the capacitance formation portion Ac.

The margin portions 114 and 115 may include a first margin portion 114 disposed on the fifth surface 5 of the body 110 and a second margin portion 115 disposed on the sixth surface 6. That is, the margin portions 114 and 115 may be disposed on end surfaces of the ceramic body 110 in the width direction.

As illustrated in FIG. 3, the margin portions 114 and 115 may refer to a region between both ends of the first and second internal electrodes 121 and 122 and a boundary surface of the body 110 in a cross-section of the body 110 in the width-thickness (W-T) direction.

The margin portions 114 and 115 may basically prevent damages to the internal electrode due to physical or chemical stress.

The margin portions 114 and 115 may be formed by forming an internal electrode by applying a conductive paste on the ceramic green sheet other than the region in which the margin portion is to be formed.

Also, to suppress a step difference caused by the internal electrodes 121 and 122, after laminating, the internal electrode may be cut to be exposed to the fifth and sixth surfaces 5 and 6 of the body, and a single dielectric layer or two or more dielectric layers may be laminated on both side surfaces of the capacitance formation portion Ac in the third direction (width direction), thereby forming the margin portion 114 and 115.

Widths of the margin portions 114 and 115 may not need to be limited to any particular example. To easily implement miniaturization and high capacitance of the multilayer electronic component, the average width of the margin portions 114 and 115 may be 5-300 μm.

The average width of margin portions 114 and 115 may refer to the average size wm in the third direction of the region in which the internal electrode is spaced apart from the fifth surface, the average size in the third direction of the region in which the internal electrode is spaced apart from the sixth surface, and the average value of the sizes of the margin portions 114 and 115 in the third direction measured at five points at an equal distance on the side surface of the capacitance formation portion Ac.

In an embodiment, the average size of the third direction of the region spaced apart from the fifth and sixth surfaces of the internal electrodes 121 and 122 may be 5-300 μm.

The internal electrodes 121 and 122 may include first and second internal electrodes 121 and 122. The first and second internal electrodes 121 and 122 may be disposed alternately to oppose each other with the dielectric layer 111 included in the body 110 therebetween, and may be exposed to the third and fourth surfaces 3 and 4 of the body 110, respectively.

The first internal electrode 121 may be spaced apart from the fourth surface 4 and may be exposed through the third surface 3, and the second internal electrode 122 may be spaced apart from the third surface 3 and may be exposed through the fourth surface 4. The first external electrode 131 may be disposed on the third surface 3 of the body and may be connected to the first internal electrode 121, and the second external electrode 132 may be disposed on the fourth surface 4 of the body and may be connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. Accordingly, the first internal electrode 121 may be spaced apart from the fourth surface 4 at a predetermined distance, and the second internal electrode 122 may be spaced apart from the third surface 3 by a predetermined distance. Also, the first and second internal electrodes 121 and 122 may be spaced apart from the fifth and sixth surfaces of the body 110.

A conductive metal included in the internal electrodes 121 and 122 may be one or more of Ni, Cu, Pd, Ag, Au, Pt, In, Sn, Al, Ti and alloys thereof, but an embodiment thereof is not limited thereto.

A method of forming the internal electrodes 121 and 122 is not limited to any particular example. For example, the internal electrodes 121 and 122 may be formed by applying a conductive paste for internal electrodes including a conductive metal on a ceramic green sheet and firing the sheet. As the method of applying the conductive paste for internal electrodes, a screen-printing method or a gravure printing method may be used, but an embodiment thereof is not limited thereto.

As another example, the internal electrodes 121 and 122 may be formed using a sputtering method, a vacuum deposition method, and/or a chemical vapor deposition method.

According to an embodiment, the capacitance formation portion Ac may include outer regions Ac1 and Ac2 adjacent to the cover portions 112 and 113 and a central region Ac0 other than the outer region, the average thickness teb of the first internal electrode 121b included in the outer regions Ac1 and Ac2 may be greater than the average thickness tea of the first internal electrode 121a included in the central region Ac0, and the average thickness teb′ of the second internal electrode included in the outer regions Ac1 and Ac2 may be greater than the average thickness tea′ of the second internal electrode included in the central region.

Since a large amount of deformation stress is applied to the internal electrode disposed in the outer regions Ac1 and Ac2 during the pressing process, by increasing the thickness of the internal electrode disposed in the outer regions Ac1 and Ac2, deformation resistance of the internal electrode disposed in the outer regions Ac1 and Ac2 during the pressing process may be increased, and thermal stability may be improved during the sintering process. Accordingly, by preventing connectivity between the internal electrodes from being degraded or the thickness thereof being reduced, connectivity between the internal electrode and the external electrode may be improved. Also, warpage strength properties may be improved without disposing a dummy electrode in the cover portion.

Also, the average thickness teb of the first internal electrode 121b included in the outer regions Ac1 and Ac2 may be greater than the average thickness tea of the second internal electrode 122a included in the central region Ac0, and the average thickness teb′ of the second internal electrode 122b included in the outer regions Ac1 and Ac2 may be greater than the average thickness tea of the first internal electrode 121a included in the central region.

In an embodiment, when the average thickness of the first internal electrode included in the central region Ac0 is defined as tea, and the average thickness of the first internal electrode included in the outer regions Ac1 and Ac2 is defined as teb, 1.6≤teb/tea≤2.0 may be satisfied. Accordingly, in embodiments, the effect of improving the connectivity and warpage strength properties between the internal electrode and the external electrode may be prominent.

When the teb/tea is less than 1.6, the effect of improving connectivity between the internal electrode and the external electrode and warpage strength properties may be insufficient, and when the teb/tea is greater than 2, the thickness of the body may excessively increase, and design stability may be deteriorated.

It may not be necessary to specifically limit the values of tea and teb. For example, tea may be 300 nm or more 937.5 nm or less, and teb may be 480 nm or more 1500 nm or less.

In an embodiment, when the average thickness of the second internal electrode included in the central region Ac0 is defined as tea′, and the average thickness of the second internal electrode included in the outer regions Ac1 and Ac2 is defined as teb′, 1.6≤teb′/tea′≤2.0 may be satisfied.

When teb′/tea′ is less than 1.6, the effect of improving connectivity between the internal electrode and the external electrode and warpage strength properties may be insufficient, and when teb′/tea′ exceeds 2, the thickness of the body may excessively increase, and design stability may be deteriorated.

Tea and tea′ may satisfy 0.9≤tea/tea′≤1.1. Also, teb and teb′ may satisfy 0.9≤teb/teb′≤1.1.

That is, the first internal electrode 121a and the second internal electrode 122a included in the central region Ac0 may have substantially the same thickness except for manufacturing errors, and the first internal electrode 121b and the second internal electrode 122b included in the outer regions Ac1 and Ac2 may have substantially the same thickness except for manufacturing errors.

The average thicknesses tea, teb, tea′, and teb′ of the internal electrodes may be measured by scanning cross-sections in the first direction and the second direction of the body 110 using a scanning electron microscope (SEM) at 10,000× magnification. More specifically, the thicknesses may be measured by measuring the average value at multiple points of one internal electrode 121 and 122, for example, at 30 points at an equal distance in the second direction. That is, tea may be a value measured by selecting one of the first internal electrodes 121a disposed in the central region Ac0, and tea′ may be a value measured by selecting one of the second internal electrodes 122a disposed in the central region Ac0. Also, teb may be a value measured by selecting one or more of the first internal electrodes 121b disposed in the outer regions Ac1 and Ac2, and teb′ may be a value measured by selecting one or more of the second internal electrodes 122b disposed in the outer regions Ac1 and Ac2.

In an embodiment, the cover portions 112 and 113 may include an upper cover portion 112 disposed in an upper portion of the capacitance formation portion in the first direction and a lower cover portion 113 disposed in a lower portion in the first direction, and the outer regions Ac1 and Ac2 may include an upper outer region Ac1 adjacent to the upper cover portion and a lower outer region Ac2 adjacent to the lower cover portion, the upper outer region Ac1 may include one or more of each of the first and second internal electrodes, and the lower outer region Ac2 may include one or more of each of the first and second internal electrodes.

That is, the upper outer region Ac1 may include one or more pairs of internal electrodes 120b having a relatively great thickness, and the lower outer region Ac2 may also include one or more pairs of internal electrodes 120b having a relatively great thickness. Accordingly, in embodiments, the effect of improving connectivity between the internal electrode and the external electrode and warpage strength properties may be prominent. Here, the pair of internal electrodes 120b having a relatively great thickness may indicate a pair of a first internal electrode 121b having an average thickness of tea and a second internal electrode 122b having an average thickness of tea′.

For example, when a pair of internal electrodes 120b having a relatively great thickness is disposed only in the upper outer region Ac1 and a pair of internal electrodes 120b having a relatively great thickness is not present in the lower outer region Ac2, deformation stress applied to the internal electrode may be further concentrated on the internal electrodes disposed in the lowermost portion in the first direction, such that connectivity between the internal electrode and the external electrode may be deteriorated.

The upper outer region Ac1 and the lower outer region Ac2 may include one or more pairs of internal electrodes 120b having a relatively great thickness, and the central region Ac0 may include one or more pairs of thin internal electrodes 120a.

In an embodiment, when a sum of the numbers of the first and second internal electrodes included in the central region Ac0 is defined as Na, and a sum of the numbers of the first and second internal electrodes included in the outer regions Ac1 and Ac2 is defined as Nb, Nb/Na may be 0.04 or more. Accordingly, in embodiments, the effect of improving connectivity between the internal electrode and the external electrode and warpage strength properties may be prominent.

When Nb/Na is less than 0.04, the effect of improving connectivity between the internal electrode and the external electrode and warpage strength properties may be insufficient.

An upper limit of Nb/Na may not be specifically limited, and Nb/Na may be 25 or lower to prevent the thickness of the multilayer electronic component from being excessively increased. When the thickness of the multilayer electronic component excessively increases, mounting stability may deteriorate when the multilayer electronic component is mounted on a substrate.

In an embodiment, when the average thickness of the first internal electrode included in the central region Ac0 is defined as tea, and the average thickness of the first internal electrode included in the outer regions Ac1 and Ac2 is defined as teb, 1.8≤teb/tea≤2.0 may be satisfied, and when the sum of the numbers of the first and second internal electrodes included in the central region Ac0 is defined as Na, and the sum of the numbers of the first and second internal electrodes included in the outer regions Ac1 and Ac2 is defined as Nb, Nb/Na may be 0.04 or more and 2.59 or lower. Accordingly, the effect of improving connectivity between the internal electrode and the external electrode and warpage strength properties may be assured, and mounting stability may also be assured.

In an embodiment, when the average thickness of the first direction of the outer regions Ac1 and Ac2 is defined as tb, and the average thickness of the first direction of the central region Ac0 is defined as ta, ta/tb may be 0.03 or more. In this case, when the average thickness in the first direction of the upper outer region Ac1 is defined as tb1 and the average thickness in the first direction of the lower outer region Ac2 is defined as tb2, tb=tb1+tb2.

In an embodiment, when the average thickness in the first direction of the upper outer region Ac1 is defined as tb1 and the average thickness in the first direction of the lower outer region Ac2 is defined as tb2, 0.9≤tb1/tb2≤1.1 may be satisfied. Accordingly, stress applied to the internal electrode disposed in the upper outer region and the lower outer region may be evenly distributed, thereby increasing the effect of improving connectivity between the internal electrode and the external electrode and warpage strength properties in embodiments.

The external electrodes 131 and 132 may be disposed on the body 110. The external electrodes 131 and 132 may be disposed on the third surface 3 and the fourth surface 4 of the body 110.

The external electrodes 131 and 132 may be disposed on the third and fourth surfaces 3 and 4 of the body 110, respectively, and may include the first and second external electrodes 131 and 132 connected to the first and second internal electrodes 121 and 122, respectively.

Although the embodiment describes a structure in which the multilayer electronic component 100 has two external electrodes 131 and 132, the number or shape of the external electrodes 131 and 132 may be changed depending on the shape of the internal electrodes 121 and 122 or other purposes.

The external electrodes 131 and 132 may be formed using any material having electrical conductivity, such as a metal, and the specific material may be determined by considering electrical properties, structural stability, and may have a multilayer structure.

For example, the external electrodes 131 and 132 may include electrode layers 131a and 132a and plating layers 131b and 132b formed on the electrode layers 131a and 132a disposed in the body 110.

For a more specific example of the electrode layers 131a and 132a, the electrode layers 131a and 132a may be fired electrodes including a conductive metal and glass, or resin-based electrodes including a conductive metal and resin.

Also, as for the electrode layers 131a and 132a, the fired electrodes and resin-based electrodes may be formed in order on the body. Also, the electrode layers 131a and 132a may be formed by transferring a sheet including conductive metal on the body, or may be formed by transferring a sheet including conductive metal on the fired electrode.

A material having excellent electrical conductivity may be used as the conductive metal included in the electrode layers 131a and 132a, and is not limited to any particular example. For example, the conductive metal may be one or more of nickel (Ni), copper (Cu), and alloys thereof.

The plating layers 131b and 132b may improve mounting properties. The types of the plating layers 131b and 132b are not limited to any particular example, and may be plating layers including one or more of Ni, Sn, Pd, and alloys thereof, and may be formed as a plurality of layers.

For more specific examples of the plating layers 131b and 132b, the plating layers 131b and 132b may be Ni plating layers or Sn plating layers, and Ni plating layers and Sn plating layers may be formed in order on electrode layers 131a and 132a, or Sn plating layers, Ni plating layers, and Sn plating layers may be formed in order. Also, the plating layers 131b and 132b may include a plurality of Ni plating layers and/or a plurality of Sn plating layers.

### Embodiment

A sample chip satisfying Nb1 (the number of internal electrodes having a relatively great thickness, adjacent to the upper cover portion), Nb2 (the number of internal electrodes having a relatively great thickness, adjacent to the lower cover portion) and tea (the thickness of the internal electrode having a relatively small thickness)/teb (the thickness of the internal electrode having a relatively great thickness) in Table 1 below was manufactured, connectivity between the internal and external electrodes and warpage strength were evaluated and listed in Table 1 below.

Connectivity between the internal and external electrodes was indicated as NG when connectivity was less than 90% of capacitance of Test No. 4 based on capacitance of Test No. 4 as a reference value 100%, and connectivity was indicated as OK when connectivity was 90% or more of capacitance of Test No. 4.

As for warpage strength, 30 sample chips were prepared for 30 sample chips, the sample chips were mounted on the substrate and while pressing the opposite surface of the sample chip mounting surface up to 6 mm, when the number of samples in which peeling-off that the external electrode is separated from the body or cracks, breakage of the body, occurred is 5 or less, the sample was marked OK, and when the number of the samples were more than 5, the sample was marked NG.

TABLE 1

| | | | | | Connectivity | |
|---|---|---|---|---|---|---|
| | | | | | between internal | |
| | | | | | and external | |
| | | | | | electrodes | |
| | | | | | (contact | Warpage |
| Test No. | Na | Nb1 | Nb2 | tea/teb | therebetween) | strength |
| 1 | 102 | 2 | 0 | 1.6 | OK | NG |
| 2 | 100 | 2 | 2 | 1.4 | NG | OK |
| 3 | 100 | 2 | 2 | 1.5 | OK | OK |
| 4 | 100 | 2 | 2 | 1.6 | OK | OK |
| 5 | 96 | 4 | 4 | 1.8 | OK | OK |
| 6 | 28 | 28 | 28 | 1.8 | OK | OK |

As for Test No. 1, the internal electrode having a relatively great thickness was not disposed in the region adjacent to the lower cover portion, warpage strength was deteriorated.

As for Test No. 2, tea/teb was 1.4, indicating that connectivity between the internal and external electrodes was deteriorated.

As for Test No. 3 to 6, the internal electrode having a relatively great thickness was disposed in the region adjacent to the upper and lower cover portions, warpage strength and connectivity between the internal and external electrodes were excellent.

According to the aforementioned embodiments, by increasing the thickness of the internal electrode adjacent to the cover portion, reliability of the multilayer electronic component may be improved.

Also, connectivity between the internal electrode and the external electrode may improve.

Also, capacitance of the multilayer electronic component may improve.

Also, warpage strength of the multilayer electronic component may improve.

The embodiments do not necessarily limit the scope of the embodiments to a specific embodiment form. Instead, modifications, equivalents and replacements included in the disclosed concept and technical scope of this description may be employed. Throughout the specification, similar reference numerals are used for similar elements.

In the embodiments, the term “embodiment” may not refer to one same embodiment, and may be provided to describe and emphasize different unique features of each embodiment. The above suggested embodiments may be implemented do not exclude the possibilities of combination with features of other embodiments. For example, even though the features described in an embodiment are not described in the other embodiment, the description may be understood as relevant to the other embodiment unless otherwise indicated.

An expression used in the singular encompasses the expression of the plural, unless it has a clearly different meaning in the context.

While the embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a body including a capacitance formation portion including a dielectric layer and first and second internal electrodes disposed alternately in a first direction with the dielectric layer interposed therebetween, and cover portions disposed in an upper portion and a lower portion of the capacitance formation portion in the first direction; and
external electrodes disposed on the body,
wherein the capacitance formation portion includes outer regions adjacent to the cover portion and a central region other than the outer region, and
wherein an average thickness of the first internal electrode included in the outer regions is greater than an average thickness of the first internal electrode included in the central region, and an average thickness of the second internal electrode included in the outer regions is greater than an average thickness of the second internal electrode included in the central region.

2. The multilayer electronic component of claim 1, wherein, when an average thickness of a first internal electrode included in the central region is defined as tea, and an average thickness of the first internal electrode included in the outer regions is defined as teb, 1.6≤teb/tea≤2.0 is satisfied.

3. The multilayer electronic component of claim 2, wherein tea is 300 nm or more 937.5 nm or less, and a teb is 480 nm or more 1500 nm

4. The multilayer electronic component of claim 1,
wherein the cover portion includes an upper cover portion disposed in an upper portion of the capacitance formation portion in the first direction and a lower cover portion disposed in a lower portion of the capacitance formation portion in the first direction,
wherein the outer regions includes an upper outer region adjacent to the upper cover portion and a lower outer region adjacent to the lower cover portion, and
wherein the upper outer region includes one or more of each of the first and second internal electrodes, and the lower outer region includes one or more of each of the first and second internal electrodes.

5. The multilayer electronic component of claim 2, wherein, when an average thickness of the second internal electrode included in the central region is defined as tea′ and an average thickness of the second internal electrode included in the outer region is defined as teb′, 1.6≤teb′/tea′≤2.0 is satisfied.

6. The multilayer electronic component of claim 5, wherein tea and tea′ satisfy 0.9≤tea/tea′≤1.1, and teb and teb′ satisfy 0.9≤teb/teb′≤1.1.

7. The multilayer electronic component of claim 1, wherein, when a sum of a number of first and second internal electrodes included in the central region is defined as Na, and a sum of a number of first and second internal electrodes included in the outer regions is defined as Nb, Nb/Na is 0.04 or more.

8. The multilayer electronic component of claim 1, wherein, when a sum of a number of first and second internal electrodes included in the central region is defined as Na and a sum of a number of first and second internal electrodes included in the outer regions is defined as Nb, Nb/Na is 0.04 or more and 25 or less.

9. The multilayer electronic component of claim 1,
wherein, when an average thickness of the first internal electrode included in the central region is defined as tea and an average thickness of the first internal electrode included in the outer regions is defined as teb, 1.8≤teb/tea≤2.0 is satisfied, and
wherein, when a sum of numbers of the first and second internal electrodes included in the central region is defined as Na and a sum of numbers of the first and second internal electrodes included in the outer regions is defined as Nb, Nb/Na is 0.04 or more and 2.59 or less.

10. The multilayer electronic component of claim 1, wherein the cover portion includes the dielectric layer and does not include the first and second internal electrodes.

11. The multilayer electronic component of claim 1, wherein the cover portion includes the dielectric layer.

12. The multilayer electronic component of claim 1,
wherein the cover portion includes an upper cover portion disposed in an upper portion of the capacitance formation portion in the first direction and a lower cover portion disposed in a lower portion of the capacitance formation portion in the first direction, and the outer regions includes an upper outer region adjacent to the upper cover portion and a lower outer region adjacent to the lower cover portion, and
wherein, when an average thickness of the upper outer region in the first direction is defined as tb1 and an average thickness of the lower outer region in the first direction is defined as tb2, 0.9≤tb1/tb2≤1.1 is satisfied.

13. The multilayer electronic component of claim 1, wherein, when an average thickness in the first direction of the outer regions is defined as tb and an average thickness in the first direction of the central region is defined as ta, tb/ta is 0.03 or more.

14. The multilayer electronic component of claim 1, wherein, when an average thickness of the dielectric layer included in the central region is defined as tda and an average thickness of the dielectric layer included in the outer regions is defined as tdb, 0.9≤tdb/tda≤1.1 is satisfied.

15. A multilayer electronic component, comprising:
a top cover portion and a bottom cover portion disposed above and below a capacitance forming portion in a stacking direction, the capacitance forming portion comprising:
an uppermost pair of internal electrodes with a dielectric layer disposed therein, disposed adjacent the top cover portion,
a lowermost pair of internal electrodes with a dielectric layer disposed therein, disposed adjacent the bottom cover portion, and
central pairs of internal electrodes disposed between the uppermost and lowermost pairs,
wherein an average thickness of the central pairs of internal electrodes is smaller than an average thickness of the uppermost and/or lowermost pairs of internal electrodes.

16. The multilayer electronic component of claim 15, wherein the average thickness of the uppermost and/or lowermost pairs of internal electrodes is in a range from 1.6 times to 2.0 times that of the central pairs of internal electrodes.

17. The multilayer electronic component of claim 15, wherein the average thickness of central pairs of internal electrodes is substantially the same among the central pairs.

18. The multilayer electronic component of claim 15, wherein the average thickness of the uppermost and/or lowermost pairs of internal electrodes is substantially the same among the uppermost and/or lowermost pairs.

19. The multilayer electronic component of claim 15, wherein an average thickness of the dielectric layers disposed between the central pairs of internal electrodes is substantially the same as an average thickness of the dielectric layers disposed between the uppermost and/or lowermost pairs of internal electrodes.
